(19) United States
(12) Patent Application Publication
(10) Pub. No.: US 2012/0080054 A1
(43) Pub. Date: Apr. 5, 2012

(54) RADIATION SOURCE MODULE AND FLUID TREATMENT SYSTEM

(75) Inventors: George Traubenberg, London (CA); Christian Moglan, London (CA)

(73) Assignee: TROJAN TECHNOLOGIES, London, ON (CA)

(21) Appl. No.: 13/263,675

(22) PCT Filed: Apr. 6, 2010
(86) PCT No.: PCT/CA2010/000506

§ 371 Date: Dec. 20, 2011

Related U.S. Application Data
(60) Provisional application No. 61/202,797, filed on Apr. 7, 2009.

(51) Int. Cl. B08B 1/00

(52) U.S. Cl. 134/6; 134/184

(57) ABSTRACT

There is described a fluid treatment system particularly suited for radiation treatment of a flow of fluid (preferably water). The system comprises a fluid treatment zone for receiving a flow of fluid in contact with a surface of the fluid treatment zone. At least one elongate radiation source assembly is disposed in the fluid treatment zone. The elongate radiation source assembly has a longitudinal axis disposed transverse to a direction of fluid flow through the fluid treatment zone. The system further comprises a cleaning apparatus having at least one cleaning element in contact with an exterior surface of the at least one elongate radiation source assembly. A first motive element is provided and is operable to cause relative movement between a distal end of the at least one elongate radiation source assembly and the surface of the fluid treatment zone to define a gap therebetween. A second motive element is provided and is coupled to the cleaning system. The second motive element operable to move the cleaning system between a cleaning apparatus retracted position and a cleaning apparatus extended position. Movement of the cleaning system from the cleaning apparatus retracted position to the extended position causes debris contacting the at least one elongate radiation source assembly to be pushed into the gap. A radiation source module more use in such a fluid treatment system is also described.

### CROSS-REFERENCE TO RELATED APPLICATION

The present application claims the benefit under 35 U.S.C. §119(e) of provisional patent application Ser. No. 61/202,797, filed Apr. 7, 2009, the contents of which are hereby incorporated by reference.

### BACKGROUND OF THE INVENTION

1. Field of the Invention

In one of its aspects, the present invention relates to a fluid treatment system, particularly a fluid treatment system for treating water. In another of its aspects, the present invention relates to a cleaning apparatus. In yet another of its aspects, the present invention relates to a radiation source module containing the cleaning system. In another of its aspects, the present invention relates to a method of removing fouling materials from an exterior surface of a radiation source assembly. Other aspects of the invention will become apparent to those of skill in the art upon reviewing the present specification.

2. Description of the Prior Art

Fluid treatment systems are known generally in the art.

For example, U.S. Pat. Nos. 4,482,809, 4,872,980 and 5,006,244 [all in the name of Maarschalkerweerd and hereinafter referred to as the Maarschalkerweerd #1 Patents] all describe gravity fed fluid treatment systems which employ ultraviolet (UV) radiation.

Such systems include an array of UV lamp frames which include several UV lamps each of which are mounted within sleeves which extend between and are supported by a pair of legs which are attached to a cross-piece. The so-supported sleeves (containing the UV lamps) are immersed into a fluid to be treated which is then irradiated as required. The amount of radiation to which the fluid is exposed is determined by the proximity of the fluid to the lamps, the output wattage of the lamps and the fluid's flow rate past the lamps. Typically, one or more UV sensors may be employed to monitor the UV output of the lamps and the fluid level is typically controlled, to some extent, downstream of the treatment device by means of level gates or the like.

Depending on the quality of the fluid which is being treated, the sleeves surrounding the UV lamps periodically become fouled with foreign materials, inhibiting their ability to transmit UV radiation to the fluid. For a given installation, the occurrence of such fouling may be determined from historical operating data or by measurements from the UV sensors. Once fouling has reached a certain point, the sleeves must be cleaned to remove the fouling materials and optimize system performance.

If the UV lamp modules are employed in an open, channel system (e.g., such as the one described and illustrated in Maarschalkerweerd #1 Patents), one or more of the modules may be removed while the system continues to operate, and the removed frames may be immersed in a bath of suitable cleaning solution (e.g., a mild acid) which may be air-agitated to remove fouling materials. This practice was regarded by many in the field as inefficient, labourious and inconvenient.

In many cases, once installed, one of the largest maintenance costs associated with prior art fluid treatment systems is often the cost of cleaning the sleeves about the radiation sources.

U.S. Pat. Nos. 5,418,370, 5,539,210 and RE36,896 [all in the name of Maarschalkerweerd and hereinafter referred to as the Maarschalkerweerd #2 Patents] all describe an improved cleaning system, particularly advantageous for use in gravity fed fluid treatment systems which employ UV radiation. Generally, the cleaning system comprises a cleaning carriage engaging a portion of the exterior of a radiation source assembly including a radiation source (e.g., a UV lamp). The cleaning carriage is movable between: (i) a retracted position wherein a first portion of radiation source assembly is exposed to a flow of fluid to be treated, and (ii) an extended position wherein the first portion of the radiation source assembly is completely or partially covered by the cleaning carriage. The cleaning carriage includes a chamber in contact with the first portion of the radiation source assembly. The chamber is supplied with a cleaning solution suitable for removing undesired materials from the first portion of the radiation source assembly.

The cleaning system described in the Maarschalkerweerd #2 Patents represented a significant advance in the art, especially when implemented in the radiation source module and fluid treatment system illustrated in these patents—i.e., a fluid treatment system to which the longitudinal axis of the radiation source is disposed substantially parallel to the direction of fluid flow through the system (also referred to as a “parallel-to-flow” fluid treatment system).

In recent years, there has been interest in the so-called “transverse-to-flow” fluid treatment systems. In these systems, the radiation source is disposed in the fluid to be treated in a manner such that the longitudinal axis of the radiation source is in a transverse (e.g., orthogonal vertical orientation of the radiation sources) relationship with respect to the direction of fluid flow past the radiation source. See, for example, any one of:

International Publication Number WO 2004/000735 [Traubenberg et al.];

International Publication Number WO 2008/055344 [Ma et al.];

International Publication Number WO 2008/019490 [Traubenberg et al.];

U.S. Pat. No. 7,408,174 [From et al.]; and

U.S. provisional patent application Ser. No. 61/193,686 [Penhale et al.], filed Dec. 16, 2008.

When these fluid treatment systems have been implemented there is a problem of build-up of fouling materials on the exterior surface of the radiation sources. This is particularly a problem in the treatment of municipal waste water where such fouling materials have not been removed upstream of the UV disinfection system. The fouling material often takes the form of debris (e.g., hair, condoms, string, algae and other string-like material) which catches on the exterior surface of the radiation sources and remains there. Failure to adequately remove such fouling material leads to a number of problems, including one or more of the following:
reduced radiation dose delivered to the flow of fluid;
promotion of build-up of more fouling material;
increased hydraulic head loss of the flow of fluid as it passes through the fluid treatment zone;
increased pressure/stress on a radiation source assembly; and
potential damage to equipment.
   To the knowledge of the present inventors, there are no known fluid treatment systems that including a cleaning system capable of adequately and reliably removing such fouling material from the exterior surface of the radiation sources during operation of the system (i.e., without the need to cease operation of the system to remove the fouling material).

Accordingly, it would be desirable to have a fluid treatment system capable of removing such fouling material during operation of the system.

### SUMMARY OF THE INVENTION

It is an object of the present invention to obviate or mitigate at least one of the above-mentioned disadvantages of the prior art.

It is another object of the present invention to provide a fluid treatment system.

It is another object of the present invention to provide a radiation source module.

Accordingly, in one of its aspects, the present invention provides a fluid treatment system comprising:
a fluid treatment zone for receiving a flow of fluid in contact with a surface of the fluid treatment zone;
at least one elongate radiation source assembly disposed in the fluid treatment zone, the elongate radiation source assembly having a longitudinal axis disposed transverse to a direction of fluid flow through the fluid treatment zone;
a cleaning apparatus having at least one cleaning element in contact with an exterior surface of the at least one elongate radiation source assembly;
a first motive element operable to cause relative movement between a distal end of the at least one elongate radiation source assembly and the surface of the fluid treatment zone to define a gap therebetween; and
a second motive element coupled to the cleaning system, the second motive element operable to move the cleaning system between a cleaning apparatus retracted position and a cleaning apparatus extended position, wherein movement of the cleaning system from the cleaning apparatus retracted position to the extended position causes debris contacting the at least one elongate radiation source assembly to be pushed into the gap.

Thus, in another of its aspects, the present invention provides a radiation source module for use in a fluid treatment system, the radiation source module comprising
a first support element and a second support element;
at least one elongate radiation source assembly coupled to the first support element;
a cleaning apparatus having at least one cleaning element in contact with an exterior surface of the at least one elongate radiation source assembly;
a first motive element operable to cause relative movement between a distal end of the at least one elongate radiation source assembly and the second support element to define a gap therebetween; and
a second motive element coupled to the cleaning system, the second motive element operable to move the cleaning system between a cleaning apparatus retracted position and a cleaning apparatus extended position, wherein movement of the cleaning system from the cleaning apparatus retracted position to the extended position causes debris contacting the at least one elongate radiation source assembly to be pushed into the gap.

Thus, in one of its aspects, the present invention relates to a fluid treatment system. The fluid treatment system consists of one or more elongate radiation source assemblies having a longitudinal axis that is transverse to a direction of fluid flow through a fluid treatment zone in which the one or more radiation source assemblies is/are disposed. The radiation source assemblies are disposed in a manner such that their distal ends are very close to or in contact with the nearest surface of the fluid treatment zone (in most practical implementations of the open channel embodiment of the present fluid treatment system, this “nearest surface” is the bottom of the channel or channel floor). As used throughout this specification, the term “surface”, in the context of the fluid treatment zone, is intended to mean a surface over which fluid passes. Thus, the “surface” may be an element of the fluid treatment zone or it may be an element of the radiation source module that is placed in a flow of fluid.

In a practical implementation of the present fluid treatment system, the fluid treatment zone is in the open channel which receives a flow of fluid. The open channel has a bottom or a floor surface above which is disposed the radiation source assemblies. During normal operation of the fluid treatment system, fouling material (typically string-like debris as discussed above) will attach itself along the length of the radiation source assembly or assemblies. When it is desired to remove this fouling material, the radiation source assemblies and the surface of the fluid treatment zone are moved with respect to one another to define a gap between the two. In one embodiment, the radiation source assemblies are moved and the surface of the fluid treatment zone is fixed. In another embodiment, the radiation source assemblies are fixed and the surface of the fluid treatment zone is moved.

In either scenario, a gap is created between the distal ends of the radiation source assemblies and the surface of the fluid treatment zone. By creating such a space or gap, it is then possible to remove fouling materials which are on the radiation source assemblies by translating a cleaning system along the exterior of the radiation source assemblies. This effectively pushes the fouling material toward the distal end of the radiation source assemblies. Once the cleaning system reaches its extended position, the fouling materials are simply pushed off the end of the radiation source assemblies and are carried away by the flow of fluid. Thus, cleaning of the radiation source assemblies can be effected during operation of the fluid treatment system without the need to shut down the system for maintenance purposes.

### BRIEF DESCRIPTION OF THE DRAWINGS

Embodiments of the present invention will be described with reference to the accompanying drawings, wherein like reference numerals denote like parts, and in which:

FIG. 1 illustrates the perspective view in partial cross-section, of preferred embodiment of the present fluid treatment system;

FIG. 2 illustrates a side view of the fluid treatment system illustrated in FIG. 1 prior to removal of fouling materials from the radiation source assemblies;

FIGS. 3-7 illustrate, in a sequential manner, removal of fouling materials from the exterior of the radiation source assemblies shown in FIG. 2;

FIGS. 8 and 9 illustrate an enlarged side view of the top of the radiation source assemblies in the fluid treatment system illustrated in FIGS. 1-7;

FIGS. 10a and 10b illustrate a perspective view of the radiation source assembly used in the fluid treatment system illustrated in FIGS. 1-9;

FIGS. 11a and 11b illustrates a perspective view of the modified radiation source assembly used in the fluid treatment system illustrated in FIGS. 1-9;

FIG. 12 illustrates an enlarged side view of the distal portion of the radiation source module used in the fluid treatment system illustrated in FIGS. 11a and 11b; and

FIGS. 13 and 14 illustrate a installation of the radiation source module illustrated in FIGS. 10a and 10b in the fluid treatment system illustrated in FIGS. 1 and 2.

### DETAILED DESCRIPTION OF THE PREFERRED EMBODIMENTS

In one of its aspects, the present invention relates to a fluid treatment system. Preferred embodiments of the fluid treatment system may include any one or a combination of any two or more of any of the following features:
the fluid treatment zone may be comprised in an open channel for receiving the flow of fluid;
the open channel may comprise a floor;
the gap may be above the floor;
the surface may be comprised in the floor;
the floor may comprise a footer element configured to receive the distal end of the at least one radiation source assembly;
the first motive element may be coupled to the at least one elongate radiation source assembly;
the first motive element is operable to move a distal end of the at least one elongate radiation source assembly between a radiation source extended position and a radiation source retracted position with respect to the surface of the fluid treatment zone, the gap being present in the radiation source retracted position;
the radiation source extended position may correspond substantially to the cleaning apparatus retracted position;
the radiation source retracted position may correspond substantially to the cleaning apparatus extended position;
the radiation source extended position may correspond substantially to the cleaning system retracted position and the radiation source retracted position may correspond substantially to the cleaning system extended position;
the first motive element may be coupled to the footer element;
the first motive element may be operable to move a portion of the footer element between a footer element extended position and a footer element retracted position, the gap being present in the footer element retracted position;
the footer element extended position may correspond substantially to the cleaning apparatus retracted position;
the footer element retracted position may correspond substantially to the cleaning apparatus extended position;
the footer element extended position may correspond substantially to the cleaning system retracted position and the footer element retracted position may correspond substantially to the cleaning system extended position;
the footer element may comprise a base element and a plate element coupled to the first motive element;
the plate element may be movably engaged to the base element;
the plate element may be slidably engaged to the base element;
the longitudinal axis of the at least one elongate radiation source assembly may be disposed orthogonal to a direction of fluid flow through the fluid treatment zone;
the at least one elongate radiation source assembly may be disposed substantially vertically with respect to a fluid flow through the fluid treatment zone;
the second motive element may be manually operable to move the cleaning system between the cleaning apparatus retracted position and the cleaning apparatus extended position;
the second motive element may be semi-automatically operable to move the cleaning system between the cleaning apparatus retracted position and the cleaning apparatus extended position;
the second motive element may be automatically operable to move the cleaning system between the cleaning apparatus retracted position and the cleaning apparatus extended position;
the at least one elongate radiation source assembly may be oriented in the fluid treatment zone such that a proximal portion thereof is above the flow of fluid and the distal end thereof is within the flow of fluid;
in the cleaning apparatus retracted position, the cleaning apparatus may be out of the flow of fluid;
in the cleaning apparatus retracted position, the cleaning apparatus may be immersed in the flow of fluid;
in the cleaning apparatus extended position, the cleaning apparatus may be within 12 inches of the distal end of the at least one radiation source assembly;
in the cleaning apparatus extended position, the cleaning apparatus may be within 10 inches of a distal end of the at least one radiation source assembly;
in the cleaning apparatus extended position, the cleaning apparatus may be within 8 inches of a distal end of the at least one radiation source assembly;
in the cleaning apparatus extended position, the cleaning apparatus may be within 6 inches of a distal end of the at least one radiation source assembly;
in the cleaning apparatus extended position, the cleaning apparatus may be within 4 inches of a distal end of the at least one radiation source assembly;
in the cleaning apparatus extended position, the cleaning apparatus may be within 2 inches of a distal end of the at least one radiation source assembly;
the gap may have a dimension in the direction of the longitudinal axis of up to about 12 inches;
the gap may have a dimension in the direction of the longitudinal axis of from about 0.5 inches to about 12 inches;
the gap may have a dimension in the direction of the longitudinal axis of from about 0.5 inches to about 10 inches;
the gap may have a dimension in the direction of the longitudinal axis of from about 1 inch to about 10 inches;
the gap may have a dimension in the direction of the longitudinal axis of from about 1 inch to about 8 inches;
the gap may have a dimension in the direction of the longitudinal axis of from about 1 inch to about 6 inches;
the gap may have a dimension in the direction of the longitudinal axis of from about 1 inch to about 4 inches;
the gap may have a dimension in the direction of the longitudinal axis of from about 1 inch to about 2 inches;
a single cleaning element may be in contact with the exterior surface of one elongate radiation source assembly;
two or more cleaning elements may be in contact with the exterior surface of one elongate radiation source assembly;
the fluid treatment system may comprises a plurality of radiation source assemblies;
a single cleaning element may be in contact with the exterior surface of each elongate radiation source assembly;
two or more cleaning elements may be in contact with the exterior surface of each elongate radiation source assembly;
the cleaning element may comprise a wiper element;
the cleaning element may comprise a scraper element;
the cleaning element may comprise an annular element that surrounds a portion of the exterior surface of at least one radiation source assembly;
the cleaning element may comprise a cleaning ring having a chamber for surrounding a portion of the exterior of the radiation source assembly;
the cleaning ring further may comprise an inlet for introduction of a cleaning solution to the chamber;
the cleaning element may comprise a brush element;
the plurality of radiation source assemblies may be comprised in a radiation source module; and
the radiation source module may comprise a support element coupled to the plurality of radiation source assemblies.

In another of its aspects, the present invention relates to a method removing fouling material from an exterior surface of at least one radiation source assembly in the above-mentioned fluid treatment system, the method comprising the steps of:
(a) actuating the first motive element to cause relative movement between the distal end of the at least one elongate radiation source assembly and the surface of the fluid treatment zone to create the gap; and
(b) actuating the second motive element to move the cleaning system from the cleaning apparatus retracted position to the cleaning apparatus extended position to cause debris contacting the at least one elongate radiation source assembly to be pushed into the gap. Preferred embodiments of the method may include any one or a combination of any two or more of any of the following features:
Step (a) may be conducted before Step (b);
Step (a) may be conducted after Step (b);
Step (a) and Step (b) may be conducted concurrently.
the method may comprise the further step of: (c) actuating the first motive element to cause relative movement between the distal end of the at least one elongate radiation source assembly and the surface of the fluid treatment zone to reduce or eliminate the gap
the method may comprise the further step of: (d) actuating the second motive element to move the cleaning system from the cleaning apparatus extended position to the cleaning apparatus retracted position;
the method may comprise the further steps of: (c) actuating the first motive element to cause relative movement between the distal end of the at least one elongate radiation source assembly and the surface of the fluid treatment zone to reduce or eliminate the gap; and (d) actuating the second motive element to move the cleaning system from the cleaning apparatus extended position to the cleaning apparatus retracted position;
Step (c) may be conducted before Step (d);
Step (c) may be conducted after Step (d); and
Step (c) and (d) may be conducted concurrently.

In one of its aspects, the present invention relates to a radiation source module. Preferred embodiments of the radiation source module may include any one or a combination of any two or more of any of the following features:
the second support may comprise a footer element configured to receive the distal end of the at least one radiation source assembly;
the first motive element may be coupled to the at least one elongate radiation source assembly;
the first motive element may be operable to move a distal end of the at least one elongate radiation source assembly between a radiation source extended position and a radiation source retracted position with respect to the second support element, the gap being present in the radiation source retracted position;
the radiation source extended position may correspond substantially to the cleaning apparatus retracted position;
the radiation source retracted position may correspond substantially to the cleaning apparatus extended position;
the radiation source extended position may correspond substantially to the cleaning system retracted position and the radiation source retracted position corresponds substantially to the cleaning system extended position;
the first motive element may be coupled to the footer element;
the first motive element may be operable to move a portion of the footer element between a footer element extended position and a footer element retracted position, the gap being present in the footer element retracted position;
the footer element extended position may correspond substantially to the cleaning apparatus retracted position;
the footer element retracted position may correspond substantially to the cleaning apparatus extended position;
the footer element extended position may correspond substantially to the cleaning system retracted position and the footer element retracted position corresponds substantially to the cleaning system extended position;
the footer element may comprise a base element and a plate element coupled to the first motive element;
the plate element may be movably engaged to the base element;
the plate element may be slidably engaged to the base element;
the elongate radiation source assembly may have a longitudinal axis that is configured to be disposed transverse to a direction of fluid flow through a fluid treatment zone in the fluid treatment system;
the elongate radiation source assembly may have a longitudinal axis that is configured to be disposed orthogonal to a direction of fluid flow through a fluid treatment zone in the fluid treatment system;
the elongate radiation source assembly may have a longitudinal axis that is configured to be disposed vertically with respect to to a direction of fluid flow through a fluid treatment system in the fluid treatment system;
the second motive element may be manually operable to move the cleaning system between the cleaning apparatus retracted position and the cleaning apparatus extended position;
the second motive element may be semi-automatically operable to move the cleaning system between the cleaning apparatus retracted position and the cleaning apparatus extended position;
the second motive element may be automatically operable to move the cleaning system between the cleaning apparatus retracted position and the cleaning apparatus extended position;
the at least one elongate radiation source assembly may be configured to be oriented in a fluid treatment zone of the fluid treatment system such that a proximal portion thereof is above the flow of fluid and the distal end thereof may be within the flow of fluid;
in the cleaning apparatus retracted position, the cleaning apparatus may be out of the flow of fluid;
in the cleaning apparatus retracted position, the cleaning apparatus may be immersed in the flow of fluid;
in the cleaning apparatus extended position, the cleaning apparatus may be within 12 inches of the distal end of the at least one radiation source assembly;
in the cleaning apparatus extended position, the cleaning apparatus may be within 10 inches of a distal end of the at least one radiation source assembly;
in the cleaning apparatus extended position, the cleaning apparatus may be within 8 inches of a distal end of the at least one radiation source assembly;
in the cleaning apparatus extended position, the cleaning apparatus may be within 6 inches of a distal end of the at least one radiation source assembly;
in the cleaning apparatus extended position, the cleaning apparatus may be within 4 inches of a distal end of the at least one radiation source assembly;
in the cleaning apparatus extended position, the cleaning apparatus may be within 2 inches of a distal end of the at least one radiation source assembly;
the gap may have a dimension in the direction of the longitudinal axis of up to about 12 inches;
the gap may have a dimension in the direction of the longitudinal axis of from about 0.5 inches to about 12 inches;
the gap may have a dimension in the direction of the longitudinal axis of from about 0.5 inches to about 10 inches;
the gap may have a dimension in the direction of the longitudinal axis of from about 1 inch to about 10 inches;
the gap may have a dimension in the direction of the longitudinal axis of from about 1 inch to about 8 inches;
the gap may have a dimension in the direction of the longitudinal axis of from about 1 inch to about 6 inches;
the gap may have a dimension in the direction of the longitudinal axis of from about 1 inch to about 4 inches;
the gap may have a dimension in the direction of the longitudinal axis of from about 1 inch to about 2 inches;
a single cleaning element may be in contact with the exterior surface of one elongate radiation source assembly;
two or more cleaning elements may be in contact with the exterior surface of one elongate radiation source assembly;
the module may comprise a plurality of radiation source assemblies;
a single cleaning element may be in contact with the exterior surface of each elongate radiation source assembly;
two or more cleaning elements may be in contact with the exterior surface of each elongate radiation source assembly;
the cleaning element may comprise a wiper element;
the cleaning element may comprise a scraper element;
the cleaning element may comprise an annular element that surrounds a portion of the exterior surface of at least one radiation source assembly;
the cleaning element may comprise a cleaning ring having a chamber for surrounding a portion of the exterior of the radiation source assembly;
the cleaning ring may further comprise an inlet for introduction of a cleaning solution to the chamber;
the cleaning element may comprise a brush element;
the first support element and the second support element may be interconnected by a third support element; and
the first support element and the second support element may be interconnected by a plurality of third support elements.

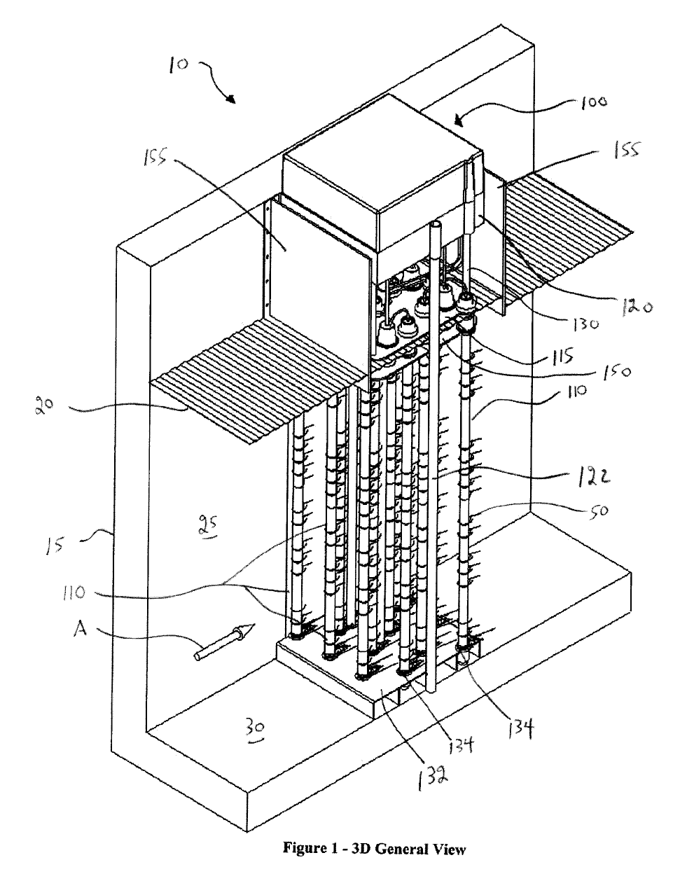

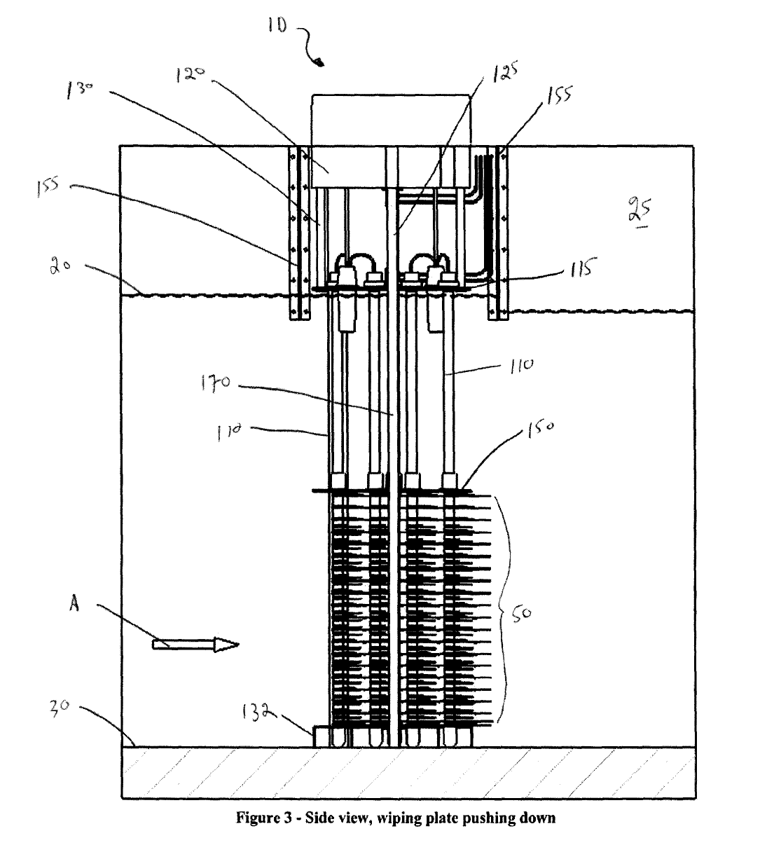

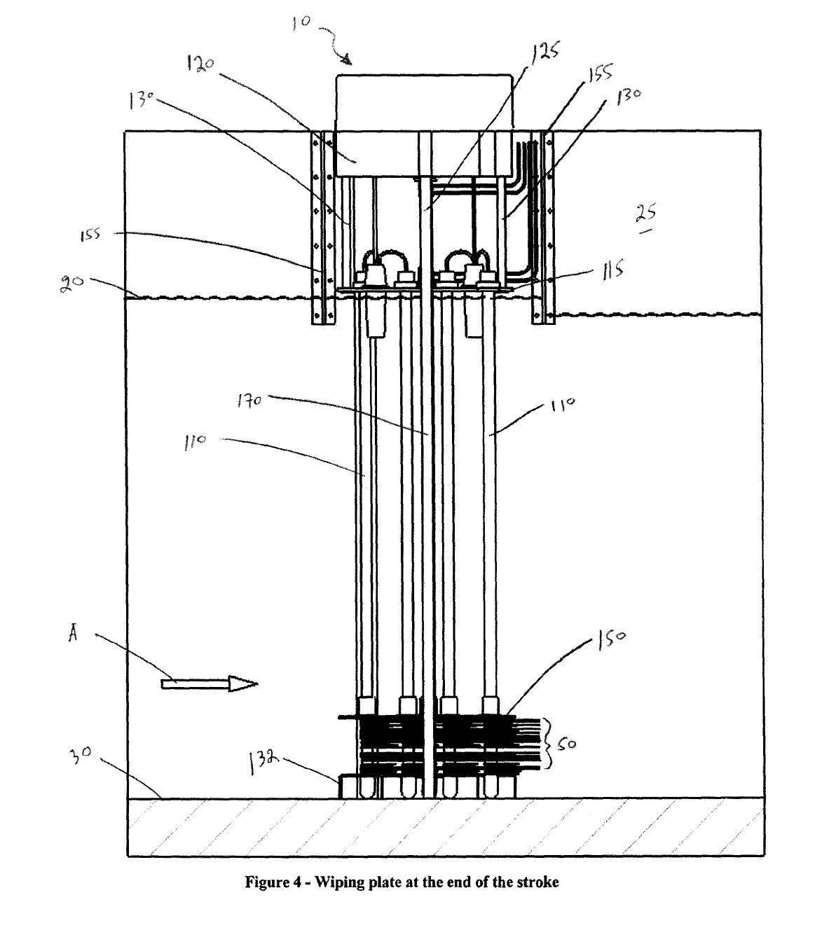

With reference to FIGS. 1-9, there is illustrated a fluid treatment system 10. Fluid treatment system 10 comprises an open channel 15 which receives a flow of fluid 20. In the illustrated embodiment, flow of fluid 20 is gravity fed in the direction of arrow A in open channel 15. Open channel 15 comprises a pair of side walls 25 (only one side wall 25 is shown in FIG. 1 for clarity) on a floor 30.

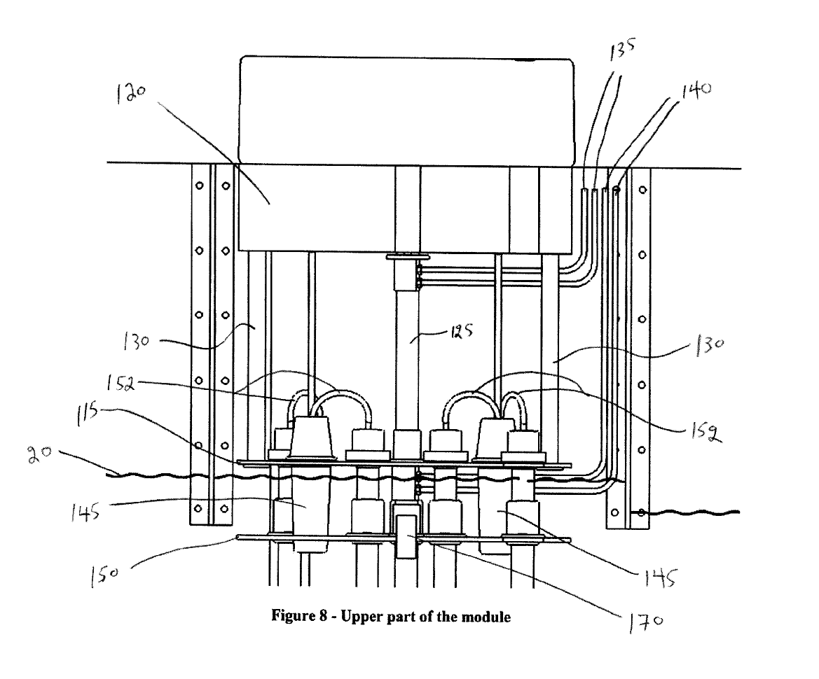

Disposed in open channel 15 is a radiation source module 100. Radiation source module 100 comprises a series of radiation source assemblies 110. The distal portions of radiation source assemblies 110 are coupled to a footer 132 that spans the distance between pair of side walls 25 of open channel 15. Footer 132 includes a series of apertures 134 1 for receiving the distal ends of radiation source assemblies. The proximal portions of radiation source assemblies 110 are connected to and supported by a support plate 115. Support plate 115 is connected to a module header 120 by a first drive element 125 (FIG. 8) and a series of upper guides 130. Support plate 115 is movable up and down over upper support guides 130 as will be discussed in more detail below.

Each radiation source assembly 110 may comprise a radiation source (not shown for clarity) disposed in a radiation transparent protective sleeve as described above in the documents referred to in Paragraphs [0004] through [0011]. Preferably, the radiation source is an ultraviolet (UV) radiation source.

A cleaning apparatus 150 is engaged with respect to the exterior of each of radiation source assemblies 110.

Cleaning apparatus 150 is connected to a second drive element 170 which drives the wiping mechanism engaged to the exterior surfaces of each radiation source assembly 110 in radiation source module 100. Preferably, second drive element 170 is of the type illustrated in U.S. Pat. No. 6,342,188 [Pearcey et al.]. More preferably, second drive element 170 is of the type illustrated in co-pending U.S. provisional patent application Ser. No. 61/202,576 [Penhale et al. (Penhale)], filed on Mar. 13, 2009.

A series of hydraulic lines 135 is connected to first drive element 125 in a conventional manner to allow for retraction or extension of support plate 115 with respect module header 120. Similarly, a series of lines 140 are connected to second drive element 170 to allow for extension and retraction of cleaning apparatus 150 with respect to module header 120. The precise nature of lines 140 and their connection to second drive element 170 will depend on whether the internals of second drive element 170 are based on hydraulic movement or mechanical movement (e.g., a screw drive as described in Pearcey and Penhale referred to in the previous paragraph).

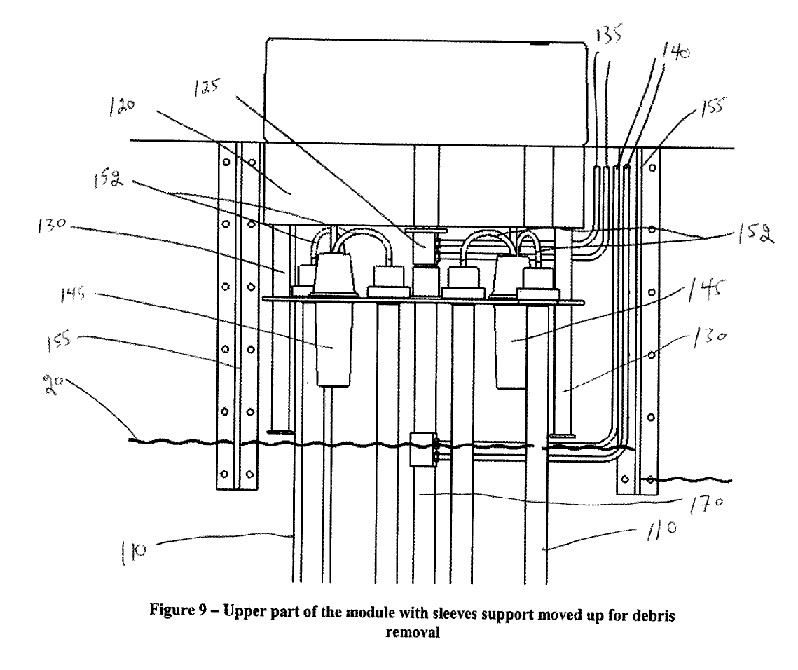

With particular reference to FIGS. 8 and 9, a ballast (or other power supply element) 145 is connected to support plate 115 and has electrical connections to a pair of radiation source assemblies 110 via leads 152. Of course, it is possible to have a single ballast for each radiation source assembly 110 or for more than two radiation source assemblies to be connected to a single ballast.

A pair of baffle plates 155 is mounted to and span a distance between side walls 25 of open channel 15. The use and function of such baffle plates is described in more detail in, for example, International Publication No. WO 2008/019490 [Traubenberg et al.] referred to above.

A pair of support elements 122 serve to interconnect modular header 120 with footer 132. This allows for radiation source module 100 to be considered as a unit or repeating element that may be placed in open channel 15 such that the bottom of footer 132 of radiation source module 100 rests on floor 30 of open channel 15.

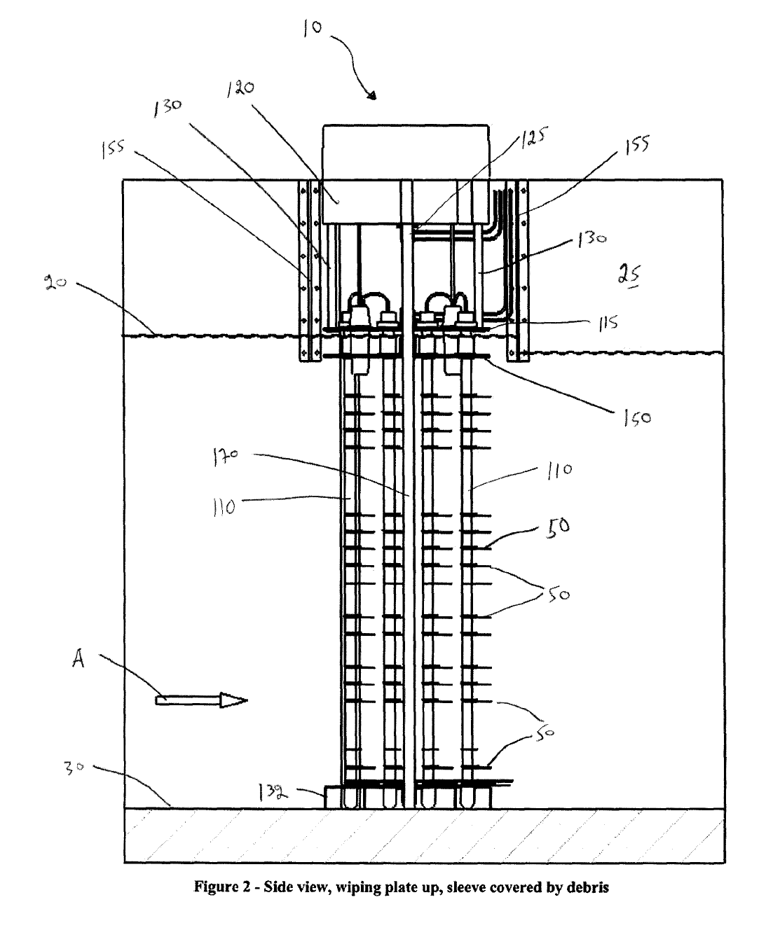

As shown in FIGS. 1-2, during normal use of fluid treatment system 10, string-like debris 50 will catch or otherwise snag on the exterior of radiation source assemblies 110.

When it is desired to remove debris 50 from the exterior surfaces of radiation source assemblies 110, second drive element 170 is actuated to translate cleaning apparatus 150 toward the distal ends of radiation source assemblies 110—see particularly FIGS. 8 and 9. This has the effect of moving debris 50 toward footer 132 as shown sequentially in FIGS. 2-4.

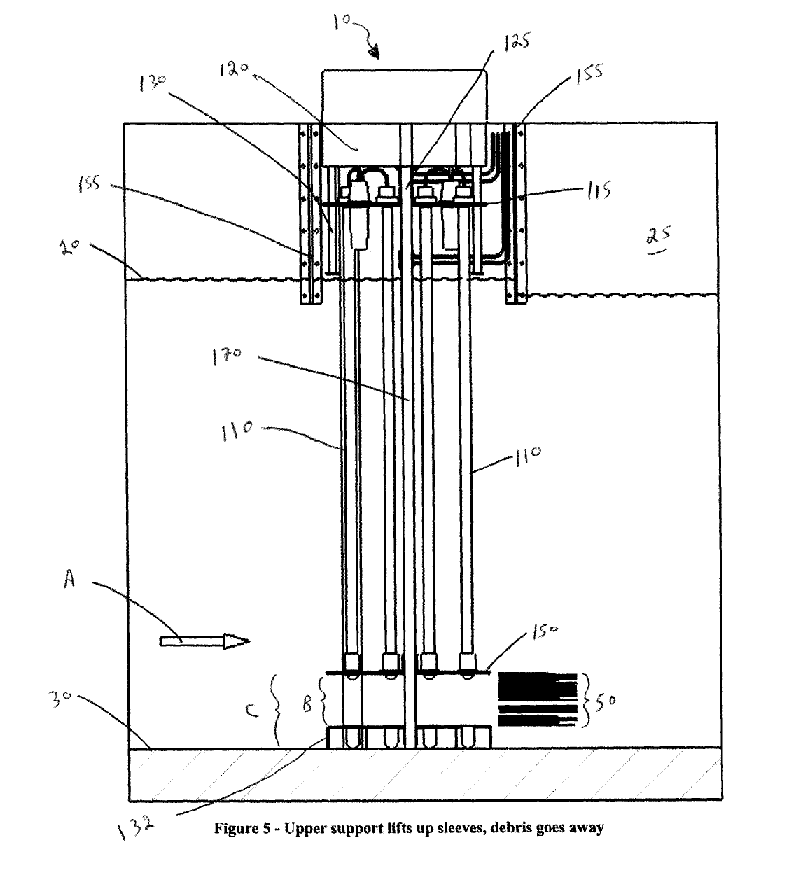

As cleaning apparatus 150 approaches the distal ends of radiation source assemblies 110, first drive element 125 is actuated to retract support plate 115 toward module header 120. This has the effect of lifting radiation source assemblies 110 toward module header 120—see FIG. 5. This lifting action of radiation source assemblies 110 creates a gap B (FIG. 5) between the distal ends of radiation source assemblies 110 and footer 132. From another perspective, the distal ends of radiation source assemblies 110 are disposed at a gap C from the surface of floor 30 of open channel 10. In either scenario, the gap is a spacing that exists between the distal ends of radiation source assemblies 110 and the surface of the fluid treatment zone of which fluid is flowing.

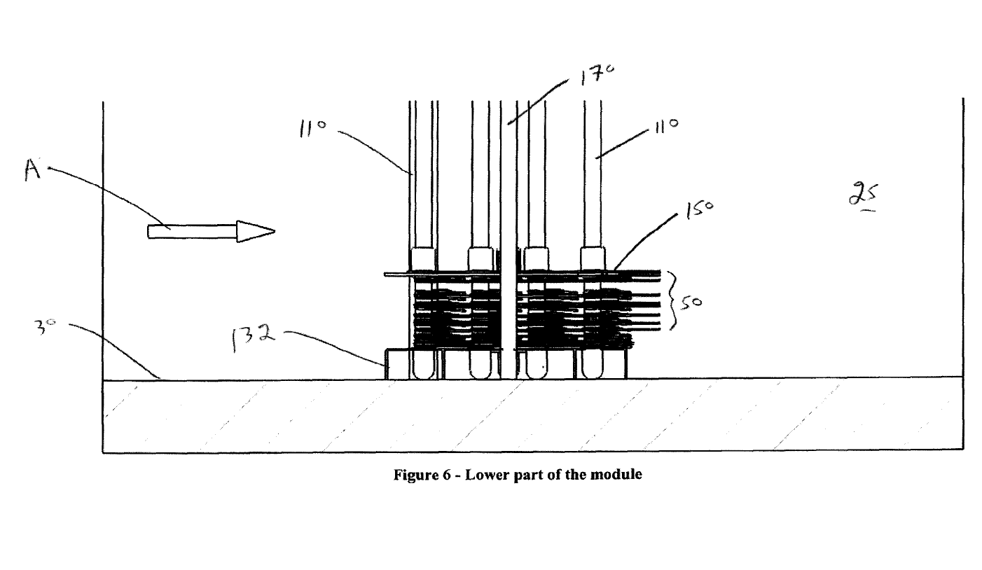

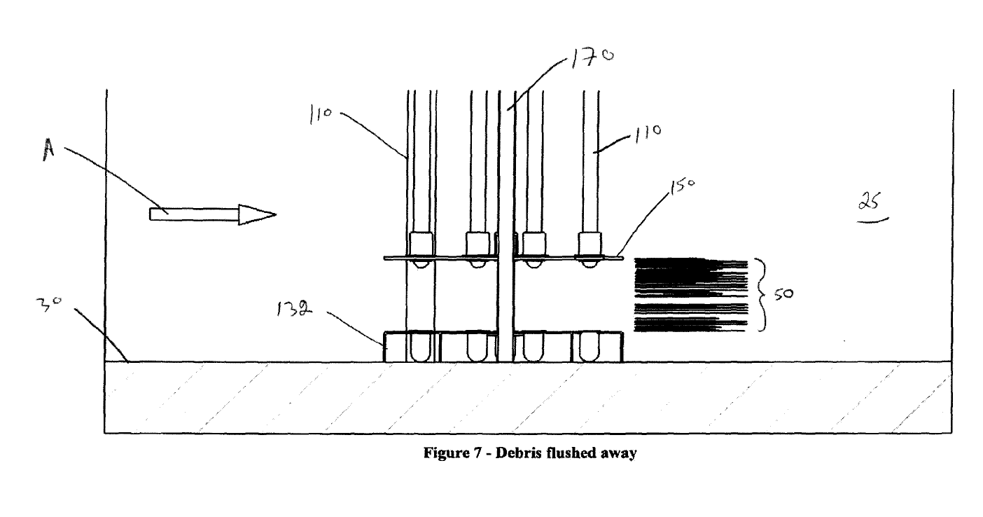

As shown in FIG. 5, the creation of this gap allows for debris 50 to be flushed away from radiation source module 100 by the flowing fluid—see also FIGS. 6-7.

After the debris is flushed away, cleaning apparatus 150 is retracted toward modular header 120 and radiation source assemblies 110 are extended so that their distal ends are received in apertures 134 of footer 132.

The timing between actuation of first drive element 125 and second drive element 170 is not particularly restricted. It is preferred to delay actuation of second drive element 170 as long as practically possible to obviate or mitigate the occurrence of short circuiting of fluid passing through gap B. As is known in the art, “short circuiting” occurs when fluid passes through a fluid treatment zone beyond a pre-determined distance at which the prescribed radiation dose is received by the fluid). An additional advantage accruing from this approach is that, to the extent footer 132 provides lateral support to the distal region of radiation source assemblies 110 prior to actuation of second drive element 170, cleaning apparatus 150 will supplement or substitute for this support (i.e., in the latter situation, when radiation source assemblies are lifted with respect to footer 132 to create the gap). Preferably, second drive element 170 is not actuated until cleaning apparatus 150 is within 12 inches, more preferably within 10 inches, more preferably within 8 inches, more preferably within 6 inches, more preferably within 4 inches of the distal end of radiation source assembles 110. Of course, it is possible to delay actuation of second drive element 170 until after first drive element 125 has moved cleaning apparatus 150 to its fully extended position (i.e., adjacent the distal end of radiation source assembles 110).

The operation of first drive element 125 and/or second drive element 170 may be manual, semi-automatic or automatic. Further, it is possible to configure a control system to actuate second drive element 170 when first drive element 125 has been actuated and cleaning apparatus 150 reaches a prescribed point of extension toward the distal of radiation source assemblies 110.

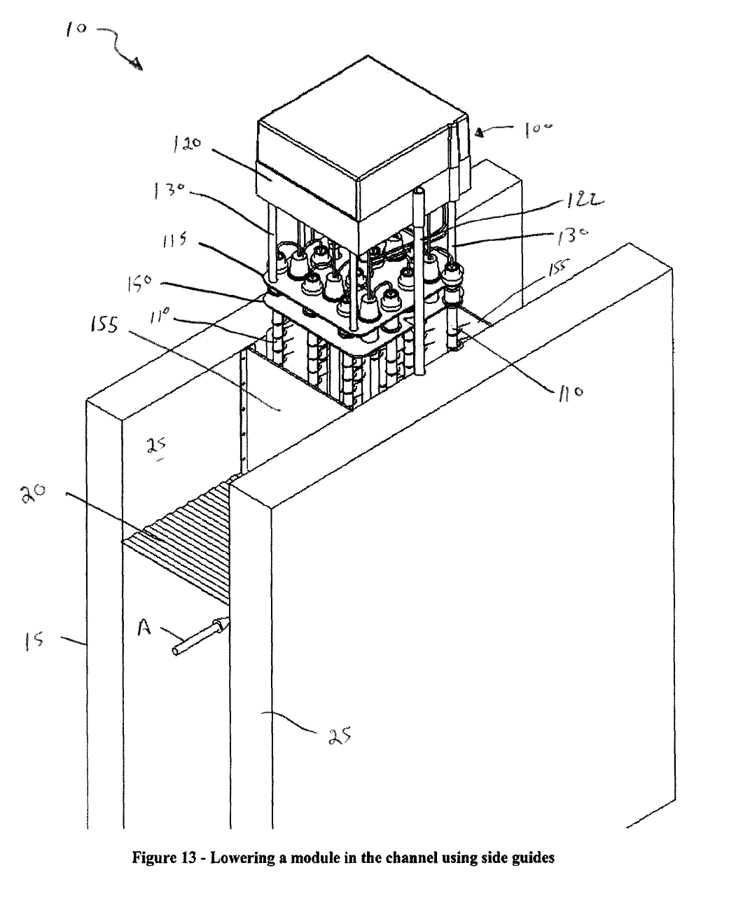

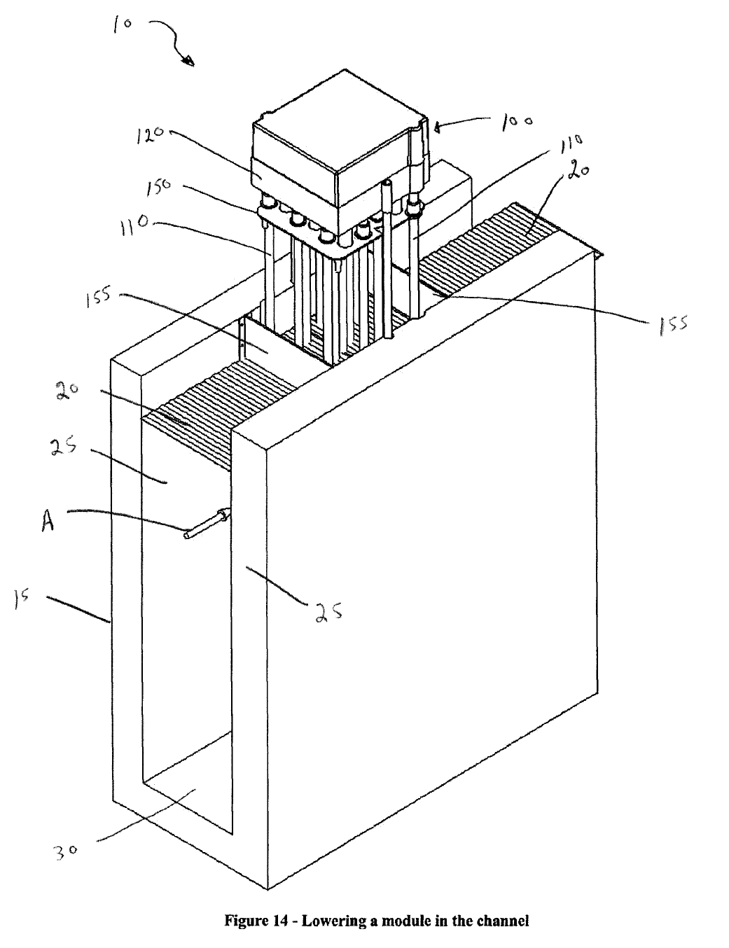

FIGS. 13 and 14 illustrate lowering of module 100 into open channel 15. As shown, side walls 25 of open channel 15 are configured to have a receptacle that receives support elements 122 on radiation source module 100. This allows for sliding radiation source module 110 down into open channel 15 to ensure for correct placement of radiation source module 100 between baffle plates 155.

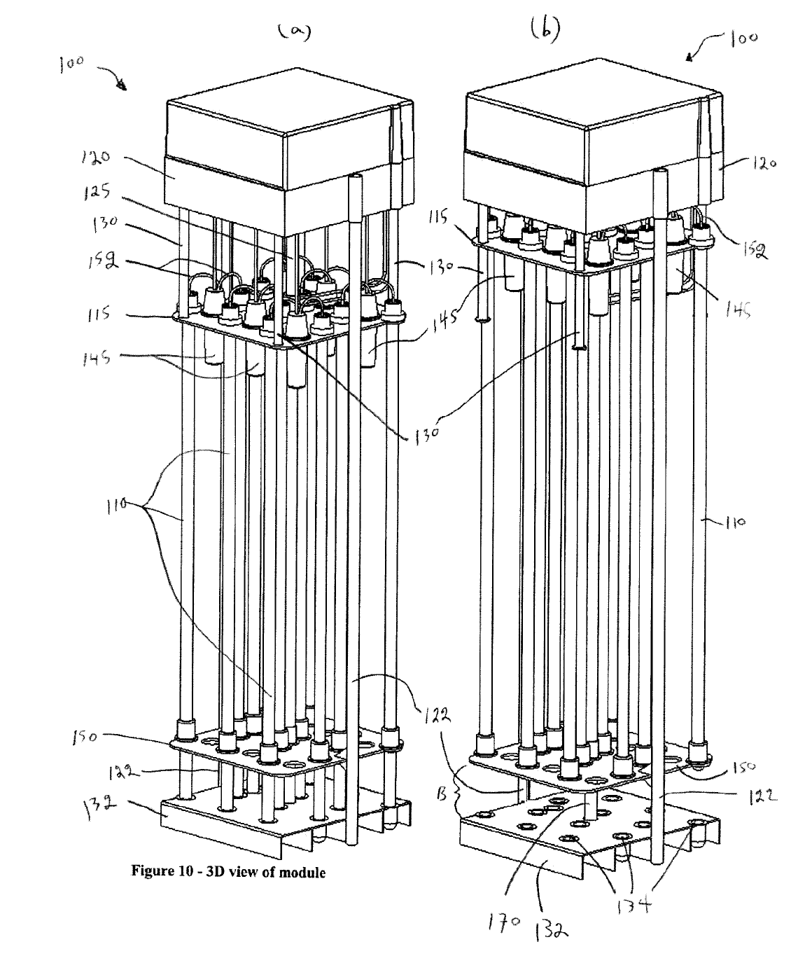

With reference to FIGS. 10a and 10b, a perspective view of module 100 is provided. As can be seen, in FIG. 10a, cleaning apparatus 150 is in the fully extended position and in FIG. 10b, support plate 115 is in the fully retracted position thereby creating gap B between cleaning apparatus 150 and the top surface of footer 132.

FIGS. 10a and 10b illustrate the modular nature of radiation source module 100. Specifically, it can be appreciated that radiation source module 100 is a repeating unit that can be disposed in an appropriately sized open channel 15. Since open channel 15 is conventional in a municipal waste water treatment plant, it is possible to relatively easily retrofit an existing open channel to include one or more radiation source modules 100, optionally having baffle plates 155 interposed between adjacent pairs of radiation source modules.

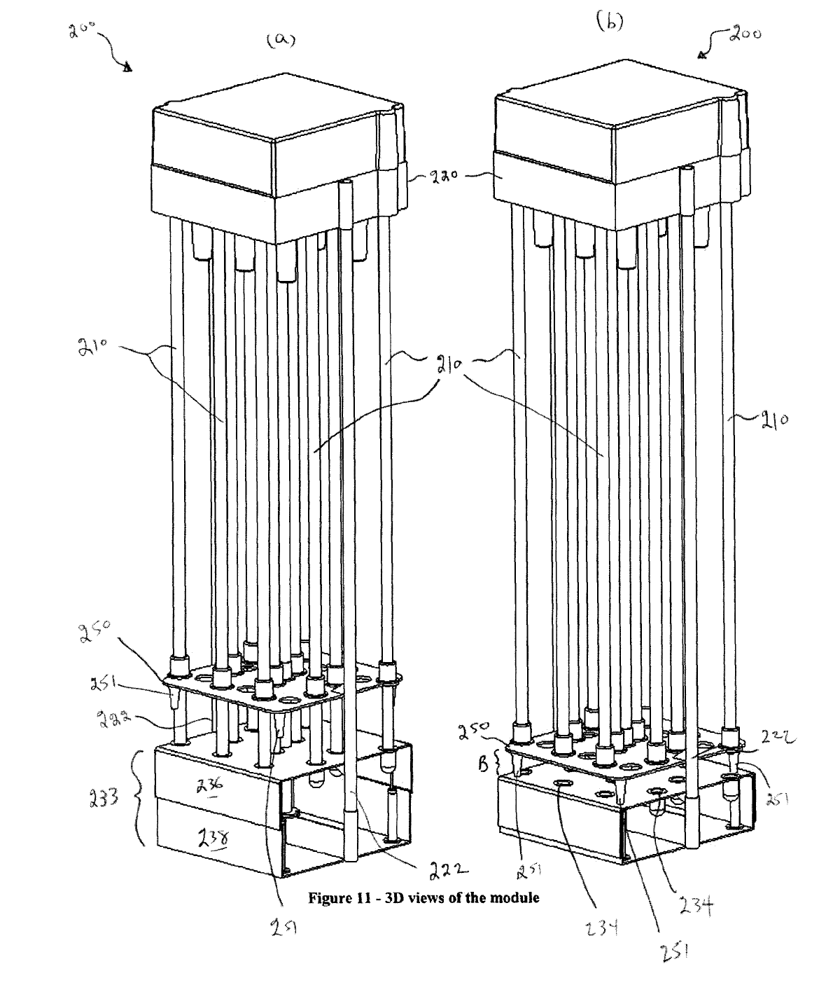

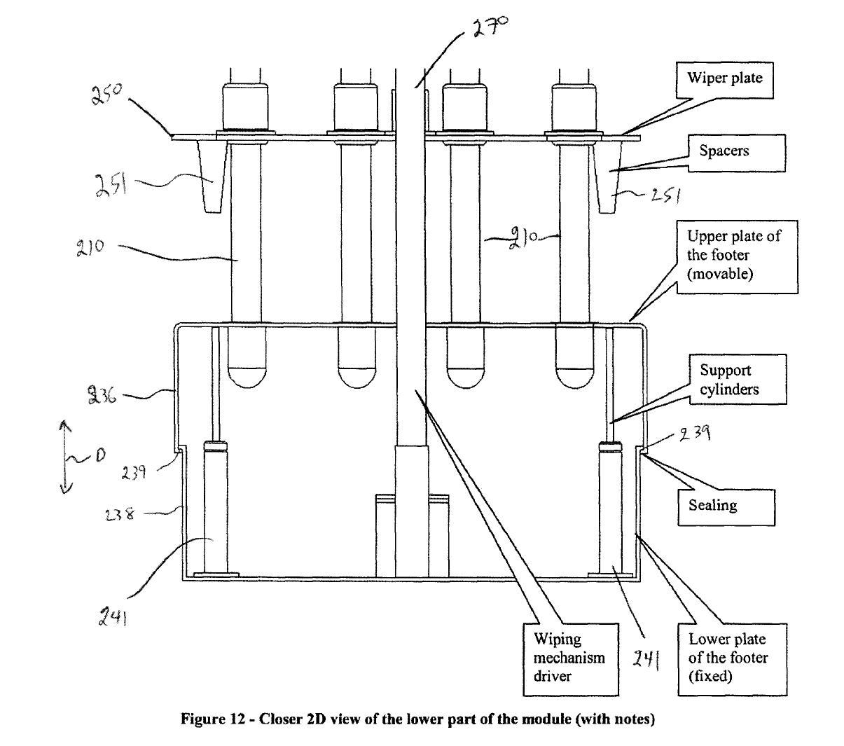

Radiation source module 100 illustrated in FIGS. 1-10 and 13-14 is based on an approach wherein radiation source assemblies 110 are moved while footer 132 is fixed to create gap B for flushing away of debris 50. It is possible, however, to use a modified approach in which the radiation source assemblies are fixed and the footer has a moveable surface to create the gap which allows the debris to be flushed away—this is illustrated in FIGS. 11-12.

FIGS. 11-12 illustrate a radiation source module 200. In FIGS. 11-12, like parts from radiation source module 100 in FIGS. 1-10 and 13-14 have the same last two digits as like parts in radiation source module 200 (e.g., for example, radiation source assemblies 110 in radiation source module 100 are denoted as radiation source assemblies 210 in radiation source module 200, module header 120 in radiation source module 100 are denoted as module header 220 in radiation source module 200, etc.).

The major modification in radiation source module 200 is the provision of a footer 233 having a movable section 236 and a fixed section 238. Sections 236,238 are in sliding engagement with each other in the direction of arrow D—see FIG. 12. Sections 236,238 may be sealed at a junction 239.

As can be seen with reference to FIG. 12, a pair of support cylinders 241 is disposed between sections 236,238. Support cylinders 241 are operable to move section 236 between a fully extended position (FIGS. 11a and 12) and a fully retracted position (FIG. 11b).

When it is desired to clean the exterior of radiation source assemblies 210, cleaning apparatus 250 is actuated in a manner similar to that described above with reference to radiation source module 100. As cleaning apparatus 250 approaches section 236 of footer 233 (FIG. 11a), support cylinders 241 are actuated to move section 236 to the retracted position (FIG. 11b). As cleaning apparatus 250 is continually extended toward footer 233, spacers 251 contact the upper surface of section 236 thereby creating gap B and allowing debris (not shown in FIGS. 11a and 11b for clarity) to be flushed away by the flowing fluid.

After the debris is flushed away, cleaning apparatus 250 is retracted toward modular header 220 and section 236 is extended away from section 238.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. For example, while the separate embodiments have been illustrated where: (i) the radiation source assemblies are moved and the surface of the fluid treatment zone is fixed, or (ii) the radiation source assemblies are fixed and the surface of the fluid treatment zone is moved, it is possible to combine (i) and (ii) in the same embodiment. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A fluid treatment system comprising:
a fluid treatment zone for receiving a flow of fluid in contact with a surface of the fluid treatment zone;
at least one elongate radiation source assembly disposed in the fluid treatment zone, the elongate radiation source assembly having a longitudinal axis disposed transverse to a direction of fluid flow through the fluid treatment zone;
a cleaning apparatus having at least one cleaning element in contact with an exterior surface of the at least one elongate radiation source assembly;
a first motive element operable to cause relative movement between a distal end of the at least one elongate radiation source assembly and the surface of the fluid treatment zone to define a gap therebetween; and
a second motive element coupled to the cleaning system, the second motive element operable to move the cleaning system between a cleaning apparatus retracted position and a cleaning apparatus extended position, wherein movement of the cleaning system from the cleaning apparatus retracted position to the extended position causes debris contacting the at least one elongate radiation source assembly to be pushed into the gap.

2. The fluid treatment system defined in claim 1, wherein the fluid treatment zone is comprised in fluid flow zone for receiving the flow of fluid.

3. The fluid treatment system defined in claim 2, wherein the fluid flow zone comprises a floor.

4. The fluid treatment system defined in claim 3, wherein the gap is above the floor.

5. The fluid treatment system defined in any one of claims 3-4, wherein the surface is comprised in the floor.

6. The fluid treatment system defined in any one of claims 3-5, wherein the floor comprises a footer element configured to receive the distal end of the at least one radiation source assembly.

7. The fluid treatment system defined in any one of claims 1-5, wherein the first motive element is coupled to the at least one elongate radiation source assembly.

8. The fluid treatment system defined in claim 6, wherein the first motive element is operable to move a distal end of the at least one elongate radiation source assembly between a radiation source extended position and a radiation source retracted position with respect to the surface of the fluid treatment zone, the gap being present in the radiation source retracted position.

9. The fluid treatment system defined in claim 7, wherein the radiation source extended position corresponds substantially to the cleaning apparatus retracted position.

10. The fluid treatment system defined in claim 7, wherein the radiation source retracted position corresponds substantially to the cleaning apparatus extended position.

11. The fluid treatment system defined in claim 7, wherein the radiation source extended position corresponds substantially to the cleaning system retracted position and the radiation source retracted position corresponds substantially to the cleaning system extended position.

12. The fluid treatment system defined in claim 6, wherein the first motive element is coupled to the footer element.

13. The fluid treatment system defined in claim 12, wherein the first motive element is operable to move a portion of the footer element between a footer element extended position and a footer element retracted position, the gap being present in the footer element retracted position.

14. The fluid treatment system defined in claim 13, wherein the footer element extended position corresponds substantially to the cleaning apparatus retracted position.

15. The fluid treatment system defined in claim 13, wherein the footer element retracted position corresponds substantially to the cleaning apparatus extended position.

16. The fluid treatment system defined in claim 13, wherein the footer element extended position corresponds substantially to the cleaning system retracted position and the footer element retracted position corresponds substantially to the cleaning system extended position.

17. The fluid treatment system defined in any one of claims 12-16, wherein the footer element comprises a base element and a plate element coupled to the first motive element.

18. The fluid treatment system defined in claim 17, wherein the plate element is movably engaged to the base element.

19. The fluid treatment system defined in claim 17, wherein the plate element is slidably engaged to the base element.

20. The fluid treatment system defined in any one of claims 1-19, wherein the longitudinal axis of the at least one elongate radiation source assembly is disposed orthogonal to a direction of fluid flow through the fluid treatment zone.

21. The fluid treatment system defined in any one of claims 1-19, wherein the at least one elongate radiation source assembly is disposed substantially vertically with respect to a fluid flow through the fluid treatment zone.

22. The fluid treatment system defined in any one of claims 1-21, where the second motive element is manually operable to move the cleaning system between the cleaning apparatus retracted position and the cleaning apparatus extended position.

23. The fluid treatment system defined in any one of claims 1-21, where the second motive element is semi-automatically operable to move the cleaning system between the cleaning apparatus retracted position and the cleaning apparatus extended position.

24. The fluid treatment system defined in any one of claims 1-21, where the second motive element is automatically operable to move the cleaning system between the cleaning apparatus retracted position and the cleaning apparatus extended position.

25. The fluid treatment system defined in any one of claims 1-24, wherein the at least one elongate radiation source assembly is oriented in the fluid treatment zone such that a proximal portion thereof is above the flow of fluid and the distal end thereof may be within the flow of fluid.

26. The fluid treatment system defined in any one of claims 1-25, wherein, in the cleaning apparatus retracted position, the cleaning apparatus is out of the flow of fluid.

27. The fluid treatment system defined in any one of claims 1-25, wherein, in the cleaning apparatus retracted position, the cleaning apparatus is immersed in the flow of fluid.

28. The fluid treatment system defined in any one of claims 1-27, wherein, in the cleaning apparatus extended position, the cleaning apparatus is within 12 inches of the distal end of the at least one radiation source assembly.

29. The fluid treatment system defined in any one of claims 1-27, wherein, in the cleaning apparatus extended position, the cleaning apparatus is within 10 inches of a distal end of the at least one radiation source assembly.

30. The fluid treatment system defined in any one of claims 1-27, wherein, in the cleaning apparatus extended position, the cleaning apparatus is within 8 inches of a distal end of the at least one radiation source assembly.

31. The fluid treatment system defined in any one of claims 1-27, wherein, in the cleaning apparatus extended position, the cleaning apparatus is within 6 inches of a distal end of the at least one radiation source assembly.

32. The fluid treatment system defined in any one of claims 1-27, wherein, in the cleaning apparatus extended position, the cleaning apparatus is within 4 inches of a distal end of the at least one radiation source assembly.

33. The fluid treatment system defined in any one of claims 1-27, wherein, in the cleaning apparatus extended position, the cleaning apparatus is within 2 inches of a distal end of the at least one radiation source assembly.

34. The fluid treatment system defined in any one of claims 1-33, wherein the gap has a dimension in the direction of the longitudinal axis of up to about 12 inches.

35. The fluid treatment system defined in any one of claims 1-33, wherein the gap has a dimension in the direction of the longitudinal axis of from about 0.5 inches to about 12 inches.

36. The fluid treatment system defined in any one of claims 1-33, wherein the gap has a dimension in the direction of the longitudinal axis of from about 0.5 inches to about 10 inches.

37. The fluid treatment system defined in any one of claims 1-33, wherein the gap has a dimension in the direction of the longitudinal axis of from about 1 inch to about 10 inches.

38. The fluid treatment system defined in any one of claims 1-33, wherein the gap has a dimension in the direction of the longitudinal axis of from about 1 inch to about 8 inches.

39. The fluid treatment system defined in any one of claims 1-33, wherein the gap has a dimension in the direction of the longitudinal axis of from about 1 inch to about 6 inches.

40. The fluid treatment system defined in any one of claims 1-33, wherein the gap has a dimension in the direction of the longitudinal axis of from about 1 inch to about 4 inches.

41. The fluid treatment system defined in any one of claims 1-33, wherein the gap has a dimension in the direction of the longitudinal axis of from about 1 inch to about 2 inches.

42. The fluid treatment system defined in any one of claims 1-41, wherein a single cleaning element is in contact with the exterior surface of one elongate radiation source assembly.

43. The fluid treatment system defined in any one of claims 1-41, wherein two or more cleaning elements are in contact with the exterior surface of one elongate radiation source assembly.

44. The fluid treatment system defined in any one of claims 1-41, comprising a plurality of radiation source assemblies.

45. The fluid treatment system defined in claim 44, wherein a single cleaning element is in contact with the exterior surface of each elongate radiation source assembly.

46. The fluid treatment system defined in claim 44, wherein two or more cleaning elements are in contact with the exterior surface of each elongate radiation source assembly.

47. The fluid treatment system defined in any one of claims 1-46, wherein the cleaning element comprises a wiper element.

48. The fluid treatment system defined in any one of claims 1-46, wherein the cleaning element comprises a scraper element.

49. The fluid treatment system defined in any one of claims 1-48, wherein the cleaning element comprises an annular element that surrounds a portion of the exterior surface of at least one radiation source assembly.

50. The fluid treatment system defined in any one of claims 1-48, wherein the cleaning element comprises a cleaning ring having a chamber for surrounding a portion of the exterior of the radiation source assembly.

51. The fluid treatment system defined in claim 50, wherein the cleaning ring further comprises an inlet for introduction of a cleaning solution to the chamber.

52. The fluid treatment system defined in any one of claims 1-48, wherein the cleaning element comprises a brush element.

53. The fluid treatment system defined in claim 44, wherein the plurality of radiation source assemblies is comprised in a radiation source module.

54. The fluid treatment system defined in claim 45, wherein the radiation source module comprises a support element coupled to the plurality of radiation source assemblies.

55. The fluid treatment system defined in any one of claims 1-54, wherein the fluid flow zone comprises an open channel.

56. The fluid treatment system defined in any one of claims 1-54, wherein the fluid flow zone comprises a closed cross-section.

57. A method removing fouling material from an exterior surface of at least one radiation source assembly in a fluid treatment system as defined in any one of claims 1-56 comprising the steps of:
(a) actuating the first motive element to cause relative movement between the distal end of the at least one elongate radiation source assembly and the surface of the fluid treatment zone to create the gap; and
(b) actuating the second motive element to move the cleaning system from the cleaning apparatus retracted position to the cleaning apparatus extended position to cause debris contacting the at least one elongate radiation source assembly to be pushed into the gap.

58. The method defined in claim 56, wherein Step (a) is conducted before Step (b).

59. The method defined in claim 56, wherein Step (a) is conducted after Step (b).

60. The method defined in claim 56, wherein Step (a) and Step (b) are conducted concurrently.

61. The method defined in any one of claims 57-60, comprising the further step of:
(c) actuating the first motive element to cause relative movement between the distal end of the at least one elongate radiation source assembly and the surface of the fluid treatment zone to reduce or eliminate the gap.

62. The method defined in any one of claims 57-60, comprising the further step of:
(d) actuating the second motive element to move the cleaning system from the cleaning apparatus extended position to the cleaning apparatus retracted position.

63. The method defined in any one of claims 57-60, comprising the further steps of:
(c) actuating the first motive element to cause relative movement between the distal end of the at least one elongate radiation source assembly and the surface of the fluid treatment zone to reduce or eliminate the gap; and
(d) actuating the second motive element to move the cleaning system from the cleaning apparatus extended position to the cleaning apparatus retracted position.

64. The method defined in claim 63, wherein Step (c) is conducted before Step (d).

65. The method defined in claim 63, wherein Step (c) is conducted after Step (d).

66. The method defined in claim 63, wherein Step (c) and Step (d) are conducted concurrently.

67. A radiation source module for use in a fluid treatment system, the radiation source module comprising:
a first support element and a second support element;
at least one elongate radiation source assembly coupled to the first support element;
a cleaning apparatus having at least one cleaning element in contact with an exterior surface of the at least one elongate radiation source assembly;
a first motive element operable to cause relative movement between a distal end of the at least one elongate radiation source assembly and the second support element to define a gap therebetween; and
a second motive element coupled to the cleaning system, the second motive element operable to move the cleaning system between a cleaning apparatus retracted position and a cleaning apparatus extended position, wherein movement of the cleaning system from the cleaning apparatus retracted position to the extended position causes debris contacting the at least one elongate radiation source assembly to be pushed into the gap.

68. The radiation source module defined claim 67, wherein the second support comprises a footer element configured to receive the distal end of the at least one radiation source assembly.

69. The radiation source module defined in any one of claims 67-68, wherein the first motive element is coupled to the at least one elongate radiation source assembly.

70. The radiation source module defined in claim 68, wherein the first motive element is operable to move a distal end of the at least one elongate radiation source assembly between a radiation source extended position and a radiation source retracted position with respect to the second support element, the gap being present in the radiation source retracted position.

71. The radiation source module defined in claim 70, wherein the radiation source extended position corresponds substantially to the cleaning apparatus retracted position.

72. The radiation source module defined in claim 70, wherein the radiation source retracted position corresponds substantially to the cleaning apparatus extended position.

73. The radiation source module defined in claim 70, wherein the radiation source extended position corresponds substantially to the cleaning system retracted position and the radiation source retracted position corresponds substantially to the cleaning system extended position.

74. The radiation source module defined in claim 68, wherein the first motive element is coupled to the footer element.

75. The radiation source module defined in claim 62, wherein the first motive element is operable to move a portion of the footer element between a footer element extended position and a footer element retracted position, the gap being present in the footer element retracted position.

76. The radiation source module defined in claim 75, wherein the footer element extended position corresponds substantially to the cleaning apparatus retracted position.

77. The radiation source module defined in claim 75, wherein the footer element retracted position corresponds substantially to the cleaning apparatus extended position.

78. The radiation source module defined in claim 75, wherein the footer element extended position corresponds substantially to the cleaning system retracted position and the footer element retracted position corresponds substantially to the cleaning system extended position.

79. The radiation source module defined in any one of claims 74-78, wherein the footer element comprises a base element and a plate element coupled to the first motive element.

80. The radiation source module defined in claim 79, wherein the plate element is movably engaged to the base element.

81. The radiation source module defined in claim 79, wherein the plate element is slidably engaged to the base element.

82. The radiation source module defined in any one of claims 67-81, wherein the elongate radiation source assembly has a longitudinal axis that is configured to be disposed transverse to a direction of fluid flow through a fluid treatment zone in the fluid treatment system.

83. The radiation source module defined in any one of claims 67-81, wherein the elongate radiation source assembly has a longitudinal axis that is configured to be disposed orthogonal to a direction of fluid flow through a fluid treatment zone in the fluid treatment system.

84. The radiation source module defined in any one of claims 67-81, wherein the elongate radiation source assembly has a longitudinal axis that is configured to be disposed vertically with respect to to a direction of fluid flow through a fluid treatment system in the fluid treatment system.

85. The radiation source module defined in any one of claims 67-84, where the second motive element is manually operable to move the cleaning system between the cleaning apparatus retracted position and the cleaning apparatus extended position.

86. The radiation source module defined in any one of claims 67-84, where the second motive element is semi-automatically operable to move the cleaning system between the cleaning apparatus retracted position and the cleaning apparatus extended position.

87. The radiation source module defined in any one of claims 67-84, where the second motive element is automatically operable to move the cleaning system between the cleaning apparatus retracted position and the cleaning apparatus extended position.

88. The radiation source module defined in any one of claims 67-87, wherein the at least one elongate radiation source assembly is configured to be oriented in a fluid treatment zone of the fluid treatment system such that a proximal portion thereof is above the flow of fluid and the distal end thereof may be within the flow of fluid.

89. The radiation source module defined in any one of claims 67-88, wherein, in the cleaning apparatus retracted position, the cleaning apparatus is out of the flow of fluid.

90. The radiation source module defined in any one of claims 67-88, wherein, in the cleaning apparatus retracted position, the cleaning apparatus is immersed in the flow of fluid.

91. The radiation source module defined in any one of claims 67-90, wherein, in the cleaning apparatus extended position, the cleaning apparatus is within 12 inches of the distal end of the at least one radiation source assembly.

92. The radiation source module defined in any one of claims 67-90, wherein, in the cleaning apparatus extended position, the cleaning apparatus is within 10 inches of a distal end of the at least one radiation source assembly.

93. The radiation source module defined in any one of claims 67-90, wherein, in the cleaning apparatus extended position, the cleaning apparatus is within 8 inches of a distal end of the at least one radiation source assembly.

94. The radiation source module defined in any one of claims 67-90, wherein, in the cleaning apparatus extended position, the cleaning apparatus is within 6 inches of a distal end of the at least one radiation source assembly.

95. The radiation source module defined in any one of claims 67-90, wherein, in the cleaning apparatus extended position, the cleaning apparatus is within 4 inches of a distal end of the at least one radiation source assembly.

96. The radiation source module defined in any one of claims 67-90, wherein, in the cleaning apparatus extended position, the cleaning apparatus is within 2 inches of a distal end of the at least one radiation source assembly.

97. The radiation source module defined in any one of claims 67-96, wherein the gap has a dimension in the direction of the longitudinal axis of up to about 12 inches.

98. The radiation source module defined in any one of claims 67-96, wherein the gap has a dimension in the direction of the longitudinal axis of from about 0.5 inches to about 12 inches.

99. The radiation source module defined in any one of claims 67-96, wherein the gap has a dimension in the direction of the longitudinal axis of from about 0.5 inches to about 10 inches.

100. The radiation source module defined in any one of claims 67-96, wherein the gap has a dimension in the direction of the longitudinal axis of from about 1 inch to about 10 inches.

101. The radiation source module defined in any one of claims 67-96, wherein the gap has a dimension in the direction of the longitudinal axis of from about 1 inch to about 8 inches.

102. The radiation source module defined in any one of claims 67-96, wherein the gap has a dimension in the direction of the longitudinal axis of from about 1 inch to about 6 inches.

103. The radiation source module defined in any one of claims 67-96, wherein the gap has a dimension in the direction of the longitudinal axis of from about 1 inch to about 4 inches.

104. The radiation source module defined in any one of claims 67-96, wherein the gap has a dimension in the direction of the longitudinal axis of from about 1 inch to about 2 inches.

105. The radiation source module defined in any one of claims 67-104, wherein a single cleaning element is in contact with the exterior surface of one elongate radiation source assembly.

106. The radiation source module defined in any one of claims 67-104, wherein two or more cleaning elements are in contact with the exterior surface of one elongate radiation source assembly.

107. The radiation source module defined in any one of claims 67-104, comprising a plurality of radiation source assemblies.

108. The radiation source module defined in claim 107, wherein a single cleaning element is in contact with the exterior surface of each elongate radiation source assembly.

109. The radiation source module defined in claim 107, wherein two or more cleaning elements are in contact with the exterior surface of each elongate radiation source assembly.

110. The radiation source module defined in any one of claims 67-109, wherein the cleaning element comprises a wiper element.

111. The radiation source module defined in any one of claims 67-109, wherein the cleaning element comprises a scraper element.

112. The radiation source module defined in any one of claims 67-111, wherein the cleaning element comprises an annular element that surrounds a portion of the exterior surface of at least one radiation source assembly.

113. The radiation source module defined in any one of claims 67-111, wherein the cleaning element comprises a cleaning ring having a chamber for surrounding a portion of the exterior of the radiation source assembly.

114. The radiation source module defined in claim 113, wherein the cleaning ring further comprises an inlet for introduction of a cleaning solution to the chamber.

115. The radiation source module defined in any one of claims 67-111, wherein the cleaning element comprises a brush element.

116. The radiation source module defined in any one of claims 67-111, wherein the first support element and the second support element are interconnected by a third support element.

117. The radiation source module defined in any one of claims 67-111, wherein the first support element and the second support element are interconnected by a plurality of third support elements.
